(19) United States
(12) Patent Application Publication
(10) Pub. No.: US 2003/0161507 A1
(43) Pub. Date: Aug. 28, 2003

(54) Method and apparatus for performing facial recognition with a hand-held imaging device

(75) Inventor: Nabil M. Lawandy, North Kingstown, RI (US)

Correspondence Address: HARRINGTON & SMITH, LLP, 4 RESEARCH DRIVE, SHELTON, CT, 06484-6212, US

(73) Assignee: Spectra Systems Corporation

(21) Appl. No.: 10/376,149

(22) Filed: Feb. 28, 2003

Related U.S. Application Data
(60) Provisional application No. 60/361,175, filed on Feb. 28, 2002.

(51) Int. Cl. G06K 9/00

(52) U.S. Cl. 382/118

(57) ABSTRACT

A facial image capture and recognition system in accordance with these teachings includes a portable, hand-held device (5) having a facial image capture sub-system (20) for generating digital data representing an image of a face of an individual from one or more desired vantage points, angles and/or distances. A data processor (20, 115) operates to process the digital data for comparing the digital data to at least one target facial image (18A). A wireless link (95) is provided for transmitting at least one of image digital data or a recognition result from the device to a remote data processor (115). The target facial image can be stored in the portable, hand-held device, and can be received through the wireless link from a data communications network, such as the Internet (105). These teachings also pertain to methods for using the portable, hand-held device and related systems.

### CLAIM OF PRIORITY TO A COPENDING U.S. PROVISIONAL PATENT APPLICATION

This patent application claims priority under 35 U.S.C. § 119(e) from copending Provisional Application No.: 60/361,175, filed Feb. 28, 2002.

### FIELD OF THE INVENTION

These teachings relate to methods and apparatus for performing facial recognition using a hand-held reader device containing a target facial image, as well as to techniques for inputting target facial image information into the reader device, such as from a data communications network, including but not limited to the Internet, as well as to techniques for outputting facial recognition results from the reader device.

### BACKGROUND OF THE INVENTION

Image capture devices are becoming more prevalent in modem society and can be widely found in financial institutions, mass transport hubs such as airport terminals and train stations, casinos, as well as in use on city streets for traffic and crowd control purposes. While the relative benefits of increased surveillance of the general population may be debated, it is a fact of modern life that digital and other types of cameras installed in public places to view persons are becoming more ubiquitous.

Another modem trend is to couple the use of such cameras with image recognition software, specifically software developed for identifying and recognizing a person's facial characteristics. Reference can be had, as examples of facial recognition systems and algorithms, to the following U.S. Pat. Nos.: 6,292,575, “Real-time facial recognition and verification system”, Bortolussi et al.; 6,137,896, “Method of recognizing faces using range images”, Chang et al.; 6,111,517, “Continuous video monitoring using face recognition for access control”, Atick et al.; 6,108,437, “Face recognition apparatus, method, system and computer readable medium thereof, Lin; 5,870,138, “Facial image processing”, Smith et al.; 5,710,833, “Detection, recognition and coding of complex objects using probabilistic eigenspace analysis”, Moghaddam et al.; and 5,625,704, “Speaker recognition using spatiotemporal cues”, Prasad.

For the case where an image exists of a certain person that it is desirable to subsequently locate and identify using facial recognition systems, also referred to herein for convenience as a target facial image, the problem arises that the target facial image may have been obtained in an uncontrolled environment and may thus not be an ideal image upon which to base a search. For example, assume that the target facial image was obtained from a video camera installed at an Automatic Teller Machine (ATM), and that the individual when using the ATM intentionally avoided having a full frontal facial image captured. The individual could have worn a cap, and may have avoided raising their head and looking directly at the location of the camera. Assume then that only at best a partial, non-frontal facial image was captured in one frame of the ATM video camera. This partial image will obviously not be an optimum target facial image upon which to base a future search for this individual when automatically monitoring the output of cameras located in an airport terminal or some other location, especially when these cameras are most likely mounted in different positions and distances relative to persons than the ATM camera, and as well most likely operate under different lighting conditions. The end result is that the person that it is desired to be located may not be recognized by the facial image identification system, as the quality of the target facial image is less than optimum.

### SUMMARY OF THE INVENTION

These teachings are directed to a hand-held, portable apparatus for obtaining an image of a face. The apparatus may execute facial image recognition algorithms based upon a stored representation of a target facial image, either alone or in cooperation with a remote data processor. The apparatus includes a wireless link, such as an IR or an RF link, for communicating with the remote data processor. Data representing the target facial image may be inputted to the apparatus using the wireless link, or the data can be loaded using a wired connection, or by inserting a preprogrammed memory card or media. The result of a facial recognition operation can be transmitted form the apparatus using the wireless link.

In accordance with an aspect of this invention an operator of the apparatus is enabled to readily position the image capture device of the apparatus relative to an individual's face from a plurality of different vantage points, distances and angles, and thereby more readily duplicate the vantage point, distance and angle from which the target facial image was obtained, thereby increasing the probability of obtaining a valid recognition result.

The apparatus can operate in conjunction with other recognition systems and techniques, such as biometric techniques including voice recognition and iris imaging.

A facial image capture and recognition system in accordance with these teachings includes a portable, hand-held device having a facial image capture sub-system for generating digital data representing an image of a face of an individual from one or more desired vantage points, angles and/or distances. A data processor operates to process the digital data for comparing the digital data to at least one target facial image. A wireless link is provided for transmitting at least one of image digital data or a recognition result from the device to a remote data processor. The target facial image can be stored in the portable, hand-held device, and can be received through the wireless link from a data communications network, such as the Internet. The wireless link may also be used to transmit other data related to the image digital data or the recognition result. This other data may be, but is not limited to, location data for indicating a location of the portable, hand-held device.

These teachings also pertain to methods for using the portable, hand-held device and related systems.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a block diagram showing the major sub-components of a hand-held, portable apparatus for obtaining an image of a face and for executing a facial recognition algorithm using a target facial image;

FIG. 2 is an elevational view of the apparatus of FIG. 1; and

FIG. 3 is a simplified block diagram of the hand-held, portable apparatus having a wireless link to a remote data processor, such as one that is a source of target facial images.

### DETAILED DESCRIPTION OF THE PREFERRED EMBODIMENTS

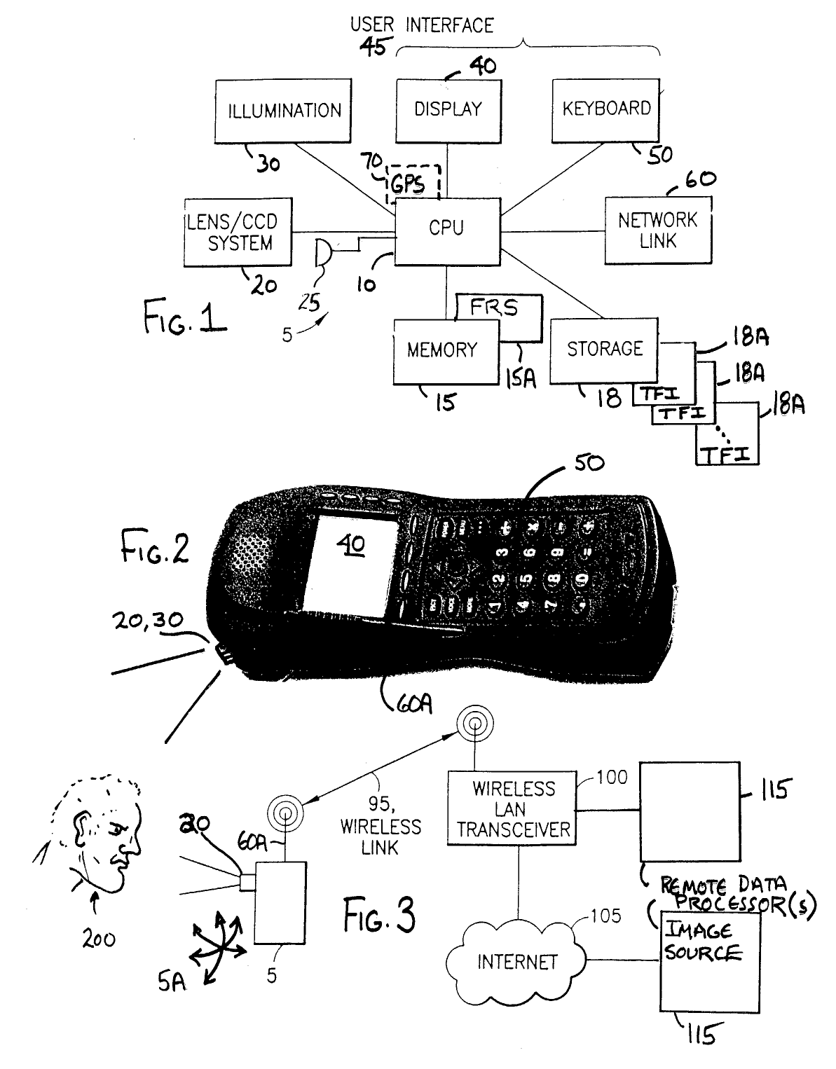

Referring to FIGS. 1 and 2, the hand-held, portable facial image capture and recognition apparatus or device 5 includes a CPU 10, such as an embedded microprocessor, an internal read/write memory 15 and optional, preferably non-volatile mass storage 18. Also included is a digital camera lens/CCD system 20, an optional at least one illumination source 30 and a user interface 45 that includes a display (LCD) 40 and a keypad or keyboard 50. The illumination source 30 can be a variable intensity source controlled by an operator, and it can also include a flash source. However, in some embodiments the illumination source 30 may not be necessary. The lens/CCD system 20 and illumination source 30 can be located on a surface opposite that of the display and keyboard 50, enabling the operator to view the image being captured on the display 40, and to manipulate the keys of the keyboard 50 such as to adjust the image capture process, initiate the operation of the facial recognition software (FRS) 15A stored in the memory 15 or 18, and perform other functions, such as initiating a transfer of a captured image to a remote location via a wireless network link 60 having, for an RF embodiment, an antenna 60A. The lens/CCD system 20 includes a digital camera of adequate resolution (e.g., 1.45 mega pixels or greater), with appropriate support circuitry providing auto-focus and other typically found features.

An optional microphone 25 can be provided.

The device 5 is battery powered, and is sized so that it can be readily manipulated with one hand by the operator, in much the same manner that a digital camera or a wireless telecommunications device can be manipulated by a user.

In accordance with a preferred embodiment of this invention the memory 15, or more preferably the non-volatile storage 18, includes one or more data sets representing target facial images (TFIs) 18A that are preloaded into the device 5. Note that the data representing a particular TFI 18A may not be image data at all, but could instead include a set of feature vectors and other data forms that are extracted from an image of an individual of interest using suitable recognition algorithm(s).

Referring also to FIG. 3, the device 5 may execute facial image recognition algorithms based upon the stored TFIs 18A, either alone or in cooperation with one or more remote data processors 115. As shown in FIG. 3, a wireless link 95 exists between device 5 and a wireless local area network (LAN) transceiver 100 that can be coupled directly to a first remote data processor 115A, and possible coupled indirectly to a second remote data processor 115B through a wide area network (WAN), such as the Internet 105. Either one or both of the remote data processors 115 can be a source of TFIs 18A that are transferred into the device 5 using the wireless link 95 and associated components. Data representing one or more target facial images 18A may be inputted to the device 5 using the wireless link 95, or the data can be loaded using a wired connection, such as through a USB port, or by inserting a preprogrammed memory card or media. That is, in one embodiment the storage 18 may be removable from and installable within the device 5.

The TFIs 18A can thus be updated as new and better images of certain individuals are obtained, and may be broadcast to a large number of devices 5 for updating them en masse while they are in use in the field.

One or more of the remote data processors 115 could be associated with a law enforcement agency or with an international, national or a local governmental agency. The result of a facial recognition operation executed by the FRS 15A may be transmitted from the apparatus using the wireless link 95, either alone or in conjunction with raw or processed facial image data captured from an individual 200.

In operation, an operator of the device 5 holds the device 5 so as to obtain an image of the face of the individual 200, and is enabled to readily change the location of the device 5 relative to the individual's face so as to obtain images from different angles, vantage points and distances in an attempt to approximate the angle, vantage point and/or distance from which one of the TFIs 18A was obtained. To facilitate this operation a TFI 18A of interest may be displayed to the operator on the display 40, either alone or in a split screen fashion with the image of the individual 200 that is being captured, thereby assisting the operator in positioning the device 5 at the most optimum position relative to the face of the individual 200. The end result is that the operator obtains an image of the individual 200 that increases the probability of obtaining an accurate facial recognition result based on the TFI or TFIs of the individual of interest.

In accordance with an aspect of this invention the operator of the device 5 is enabled to readily position the image capture system (lens/CCD system 20) of the device 5 relative to the face of the individual 200 from a plurality of different vantage points, distances and angles (indicated generally by the axes 5A), and thereby can more readily duplicate the vantage point, distance and angle from which the target facial image 18A was obtained, thereby increasing the probability of obtaining a valid recognition result.

The CPU 10 executes software that is suitable for preprocessing the image of the face of the individual 200 into a form that is suitable for performing the desired type of FRS 15A. In one embodiment the entire FRS algorithm is executed by the CPU 10, and it provides a recognition result or probability locally to the operator, and optionally to one or more of the remote data processors 115. In another embodiment the CPU 10 may only pre-process the captured image data, such as to extract certain facial feature vectors and/or to filter the data to remove noise and artifacts, and then compresses the data using a suitable algorithm and transmits the data to one or more of the remote data processors 115 for completion of the FRS algorithm. In another embodiment the device 5 may function simply as a portable image capture device, and all or substantially all FRS processing is performed by the remote data processor(s) 115. In these latter two embodiments the remote data processor 115 may transmit a result of the recognition algorithm back to the device 5 for display to the operator, along with any other desired relevant information, such as the name of the individual if the face is recognized.

The specific type or types of facial image recognition software and algorithms that are executed are not germane to the teachings of this invention. For example, one of those referenced above could be used.

Note further that the lens/CCD system 20 could be operated as well in a continuous video mode and other recognition techniques could be employed, such as one referred to above that employs images of a speaker's mouth for achieving speaker recognition (U.S. Pat. No.: 5,625,704, “Speaker recognition using spatiotemporal cues”, Prasad.)

It is within the scope of these teachings to include some type of location determining system within the device 5, such as one based on the Global Positioning System (GPS) 70. In this case the location of the device 5, and hence the location of the individual 200, can be transferred to the remote data processor(s) 115 along with the recognition result, the preprocessed facial image data or with the raw image data. Other location techniques can be used as well, such as triangulation when there are at least three wireless LAN transceivers 100 positioned for receiving the transmissions from the device 5.

While described in the context of the hand-held, portable facial image capture and recognition device 5, it should be appreciated that certain aspects of these teachings may be practiced with systems that are not portable or hand-held, or that are intended to be operated in a fixed location, or that are integrated into larger systems, such as metal detecting systems at building entrances and in passenger terminals. In some applications the device 5 could be installed within or with another type of hand-held device, such as a portable data terminal or a voice communication device, such as a cellular telephone. In this latter case the wireless link 95 could be a cellular system RF link.

Further by example, the device 5 could be combined with the hand-held metal detector wand that is used by security personnel at airline terminals and at other locations where individuals are examined and screened.

Note as well that the transmitted data derived from processing facial image data of the individual 200 may be combined with other data that is automatically generated or that is manually entered into the device 5 using the keyboard 50.

Note as well that the device 5 can operate in conjunction with other recognition systems and techniques, such as biometric techniques including voice recognition, iris imaging and/or fingerprint imaging. The voice recognition technique can be facilitated through the use of the microphone 25, which may form a part of a conventional cellular telephone that is built into the device 5. In this case the individual's voice is sampled and processed, either locally within the device 5 or remotely, after having been transmitted through the network link 60. In the former case target voice recognition patterns may be pre-stored in the device 5.

A result is that a recognition result for a given individual may be based on a number of criteria, including a face recognition result and at least one other type of recognition result, such as voice, iris and/or fingerprint.

Thus, it should be appreciated that while these teachings have been particularly shown and described with respect to preferred embodiments thereof, it will be understood by those skilled in the art that changes in form and details may be made therein without departing from the scope and spirit of the invention.

What is claimed is:

1. A facial image capture and recognition system, comprising:
a portable, hand-held device comprising a facial image capture sub-system for generating digital data representing an image of a face of an individual from one or more desired vantage points, angles and/or distances; and
a data processor for processing the digital data for comparing the digital data to at least one target facial image.

2. A system as in claim 1, further comprising a wireless link for transmitting at least one of image digital data or a recognition result from the device to a remote data processor.

3. A system as in claim 1, where the target facial image is stored in the portable, hand-held device.

4. A system as in claim 2, where the target facial image is received through said wireless link from a data communications network for storage within said portable, hand-held device.

5. A system as in claim 4, where said data communications network comprises the Internet.

6. A system as in claim 2, where the wireless link comprises an interface to a remote data processor that is reachable through the Internet.

7. A system as in claim 6, where said data processor that processes said digital data comprises said remote data processor.

8. A system as in claim 2, where the wireless link also transmits other data related to the image digital data or the recognition result.

9. A system as in claim 8, where the other data comprises at least one of location data for indicating a location of the device and biometrics data related to the individual.

10. A system as in claim 2, where the device comprises a telecommunications device, and where the wireless link comprises a cellular link.

11. A method to perform facial image capture and recognition, comprising:
generating digital data representing an image of a face of an individual from one or more desired vantage points, angles and/or distances using a portable, hand-held device comprising a facial image capture sub-system; and
processing the digital data for comparing the digital data to at least one target facial image.

12. A method as in claim 11, further comprising a wireless link for transmitting at least one of image digital data or a recognition result from the device to a remote data processor.

13. A method as in claim 11, where the target facial image is stored in the portable, hand-held device.

14. A method as in claim 12, further comprising:
receiving the target facial image through said wireless link from a data communications network; and
storing the received target facial image within said portable, hand-held device.

15. A method as in claim 14, where said data communications network comprises the Internet.

16. A method as in claim 12, where the wireless link comprises an interface to a remote data processor that is reachable through the Internet.

17. A method as in claim 16, where said data processor that processes said digital data comprises said remote data processor.

18. A method as in claim 12, where the wireless link also transmits other data related to the image digital data or the recognition result.

19. A method as in claim 18, where the other data comprises at least one of location data for indicating a location of the device and biometrics data related to the individual.

20. A method as in claim 12, where the device comprises a telecommunications device, and where the wireless link comprises a cellular link.
